(19) United States
(12) Patent Application Publication
(10) Pub. No.: US 2011/0017012 A1
(43) Pub. Date: Jan. 27, 2011

(54) Rotation assisting mechanism

(76) Inventor: Yasuaki Takegoshi, Tokyo (JP)

Correspondence Address: BACON & THOMAS, PLLC, 625 SLATERS LANE, FOURTH FLOOR, ALEXANDRIA, VA, 22314-1176, US

(21) Appl. No.: 12/458,892

(22) Filed: Jul. 27, 2009

(51) Int. Cl. H02K 7/02

(52) U.S. Cl. 74/572.11

(57) ABSTRACT

A rotation assisting mechanism to save energy for driving a rotating apparatus consists of two disc members having faces opposing to each other, axes of rotation of the faces being away from each other vertically to the respective axes, and being arranged in parallel; two or more crank-shaped members having both end shaft portions rotatably fitted to a plurality of holes formed in the respective disc members, both leg portions bending vertically from the respective end shaft portions toward the same side and having different lengths from each other, and center shaft portions coupling both the leg portions and having axes of rotation in parallel to the respective axes of rotation of both the end shaft portions; and a rotating body having a plurality of holes to which the center shaft portions of the crank-shaped members are rotatably fitted.

### BACKGROUND OF THE INVENTION

1. Field of the Invention

The present invention relates to a rotation assisting mechanism which can assist a rotational drive of a rotating apparatus, for example, a ventilating fan apparatus or the like.

2. Description of the Conventional Art

In conventional, the rotating apparatus, for example, the ventilating fan apparatus or the like is structured such that rotation of the rotating apparatus is driven by using a motor or the like employing electric energy or the like as a driving source. The rotating apparatus mentioned above includes various kinds in addition to the ventilating fan apparatus and, as energy for driving the rotating apparatus, various kinds of energy such as thermal power energy including oil, coal and the like, wind power energy, water power energy, atomic power energy and the like, are employed in addition to the electric energy.

### SUMMARY OF THE INVENTION

### Problem to be Solved by the Invention

However, at the present day when machine civilization has been progressed to a very high degree, since the civilization depends on consumption of an enormous amount of energy, there occurs a chronic energy shortage. Further, oil, coal and the like will undoubtedly dry up eventually, apparatuses for changing wind power and water power into energy are expensive, and atomic power has a great risk of radiation contamination.

Accordingly, if only the conventional energy is used, a limit will necessarily come someday to cause a problem that further energy will be consumed due to necessity of the expensive apparatuses, and even civilized living may be threatened due to occurrence of a very dangerous radiation contamination accident.

Consequently, the present invention is made by taking the problem mentioned above into consideration, and an object of the present invention is to provide a rotation assisting mechanism which can defend civilized living by largely reducing a use amount of energy for driving a rotating apparatus in comparison with a conventional one.

### Means for Solving the Problem

In order to achieve the object mentioned above, in accordance with the present invention, there is provided a rotation assisting mechanism comprising:

two disc members in which mutual faces are arranged so as to oppose to each other, axes of rotation of the faces are away from each other in a vertical direction with respect to the respective axes, and the axes of rotation are arranged so as to be in parallel to each other;

two or more crank-shaped members formed by both end shaft portions which are rotatably fitted to a plurality of holes formed in such a manner as to have axes in a vertical direction to the respective faces of said two disc members, both leg portions which are arranged so as to be in parallel to each other by bending vertically from end portions at sides close to each other of both the end shaft portions toward the same side and have different lengths from each other, and center shaft portions which couple said both leg portions by bending vertically from the respective end portions at opposite sides to said both end shaft portions of both the leg portions, and have axes of rotation in parallel to the respective axes of rotation of said both end shaft portions; and

a rotating body having a plurality of holes formed in such a manner as to have axes in a parallel direction to its own axis of rotation so that the center shaft portions of said crank-shaped members are rotatably fitted thereto.

Further, in accordance with the present invention, there is provided the rotation assisting mechanism, wherein a plurality of the holes formed in each of said two disc members are constructed by two pairs or more of shaft support holes which are formed so as to mutually make pairs with holes at positions having the same phase on pitch circles of the mutual disc members, at each of positions which are away at even intervals in a circumferential direction, on each of the pitch circles having the same diameter around the axes of rotation in each of these two disc members, and

wherein both the end shaft portions of said crank-shaped members are fitted respectively to the shaft support holes said of two disc members.

Further, in accordance with the present invention, there is provided the rotation assisting mechanism wherein the mechanism, further includes an energizing means to energize said rotating body in a vertical direction to the axis of rotation of the rotating body, and in a vertical direction to a straight line connecting the axes of rotation of said two disc members in the vertical direction to the respective axes.

Further, in accordance with the present invention, there is provided the rotation assisting mechanism, wherein the rotation of said rotating body is made transmittable to an independent rotating apparatus from said rotation assisting mechanism via a gear.

### Effect of the Invention

In accordance with such the rotation assisting mechanism of the present invention, since the rotation assisting mechanism is provided with two disc members in which the mutual faces are arranged so as to oppose to each other, the axes of rotation of the faces are away from each other in the vertical direction with respect to the respective axes, and the axes of rotation are arranged so as to be in parallel to each other, two or more crank-shaped members formed by both end shaft portions which are rotatably fitted to a plurality of holes formed in such a manner as to have the axes in the vertical direction to the respective faces of the two disc members, both leg portions which are arranged so as to be in parallel to each other by bending vertically from the end portions at the sides close to each other of both the end shaft portions toward the same side and have the different lengths from each other, and the center shaft portions which couple both the leg portions by bending vertically from the respective end portions at the opposite sides to both the end shaft portions of both the leg portions, and have the axes of rotation in parallel to the respective axes of rotation of both the end shaft portions, and the rotating body which is formed in such a manner as to have the axis in the parallel direction to its own axis of rotation, and has a plurality of holes to which the center shaft portions of the crank-shaped members are rotatably fitted, it is possible to defend civilized living by largely reducing a use amount of energy for driving the rotating apparatus in comparison with a conventional one.

### BRIEF EXPLANATION OF DRAWINGS

FIG. 1 is a side view showing a rotation assisting mechanism 2 in accordance with a first embodiment of the present invention;

FIG. 2 is a top view of the rotation assisting mechanism 2 shown in FIG. 1;

FIG. 3 is a front view of the rotation assisting mechanism 2 shown in FIG. 1;

FIG. 4 is an enlarged side view of a substantial part showing a positional relationship among two discs 4 and 6, a rotating body 20, and three crank-shaped members 8;

FIG. 5 is a view showing only the rotating body 20 in FIG. 4;

FIG. 6 is a view showing a part of a cycloid gear which engages with a pin gear of the rotation assisting mechanism 2;

FIG. 7 is a top view of a ventilating fan apparatus 35 having a cycloid gear 30 partly shown in FIG. 6 and a drive motor 39; and

FIGS. 8(a) to 8(d) are views showing a motion of the rotation assisting mechanism 2 in the order from 8(a) to 8(d).

### DETAILED DESCRIPTION OF PREFERRED EMBODIMENT

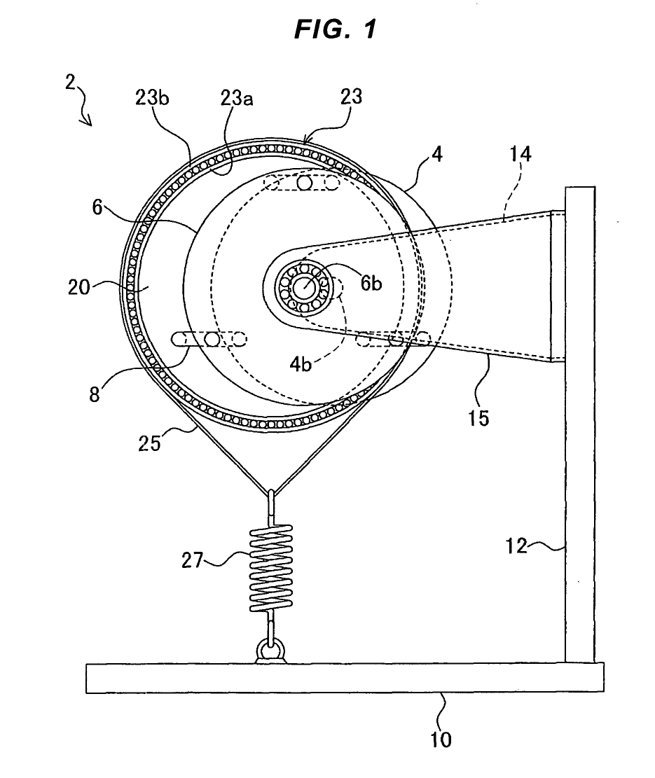

A description will be specifically given below of a rotation assisting mechanism 2 in accordance with an embodiment of the present invention with reference to FIGS. 1 to 8.

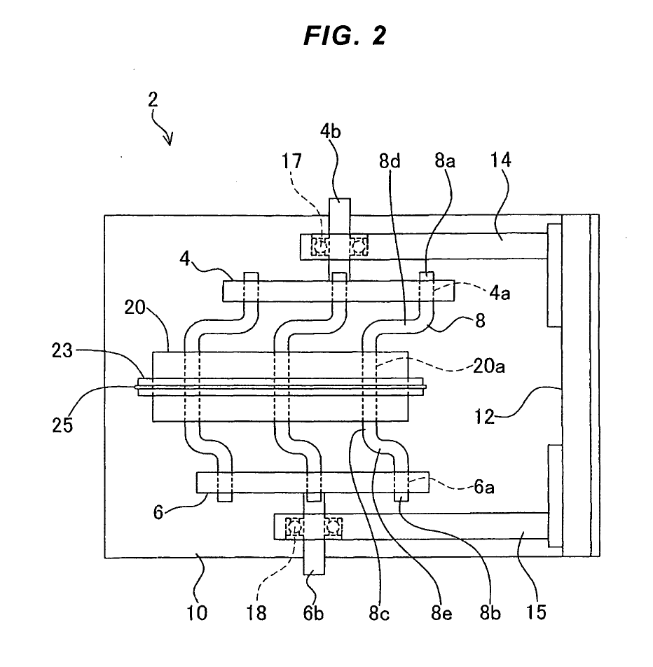

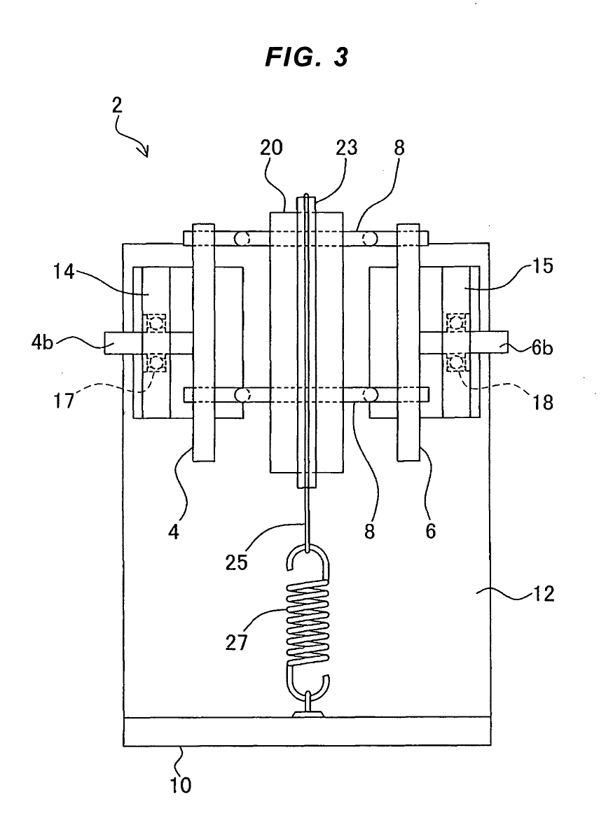

The rotation assisting mechanism 2 in accordance with the present embodiment is provided with two discs 4 and 6 (corresponding to “disc member” in claim 1), and three crank-shaped members 8, as shown in FIGS. 1 to 3. Two discs 4 and 6 are arranged in such a manner that their faces oppose to each other, where the faces are vertical to the longitudinal direction of the sheet of FIG. 2, and respective rotating shafts 4b and 6b of the discs 4 and 6 are arranged so as to be in parallel to each other, as shown in FIGS. 1 and 3, in such a manner that axes of rotation thereof are away from each other in a vertical direction (a lateral direction in FIGS. 1 and 2) while having the same height.

Further, as shown in FIGS. 1 and 2, respective base end portions (right end portions in the figures) of brackets 14 and 15 having different heights (lengths in a lateral direction in the figures) from each other are fixed to a standing plate 12 provided on a base plate 10, and the respective rotating shafts 4b and 6b of two discs 4 and 6 are rotatably supported to respective top end portions (left end portions in the figures) of the brackets 14 and 15 via bearing members 17 and 18.

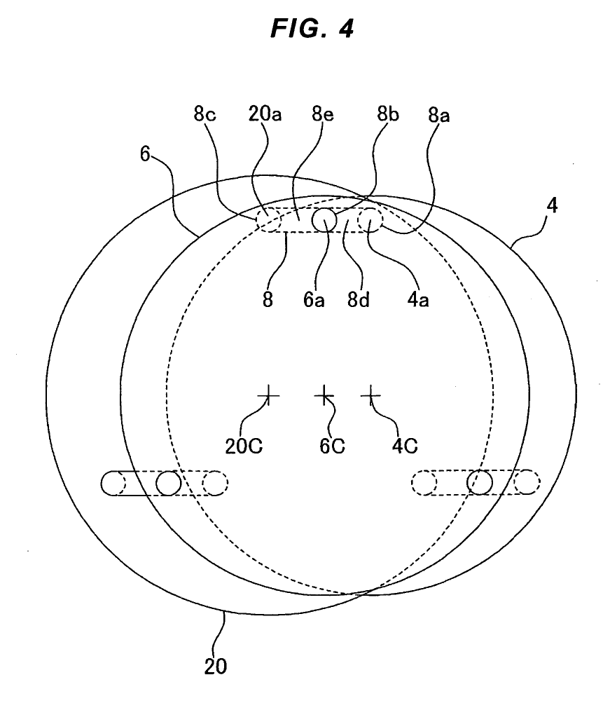

Three pairs of shaft support holes 4a and 6a are respectively formed in two discs 4 and 6 so as to pass through two discs 4 and 6, as shown in FIG. 4. Centers of the shaft support holes 4a and 6a are arranged respectively at three positions of the disc 4 and three positions of the disc 6 at intervals of 120 degree in a circumferential direction of the pitch circles having the same diameter around the center of rotation 4C and 6C, and these positions make pairs so as to keep the same phase positions on the respective pitch circles of the discs 4 and 6.

As shown in FIG. 2, three crank-shaped members 8 are arranged and provided between two discs 4 and 6. In the crank-shaped members 8, one side end portions 8a of both end portions of the crank-shaped members 8 are rotatably fitted to three shaft support holes 4a provided in the disc 4, and the other side end portions 8b of both end portions of the crank-shaped members 8 are rotatably fitted to three shaft support holes 6a provided in the disc 6.

A magnitude of the diameter of the pitch circle, on which the shaft support holes 4a, to which one side end portions 8a of the crank-shaped members 8 are fitted, are arranged in the disc 4, is set to have the same magnitude as a magnitude of the diameter of the pitch circle, on which the shaft support holes 6a, to which the other side end portions 8b of the crank-shaped members 8 are fitted, are arranged in the disc 6.

In the crank-shaped member 8, a center length portion 8c is away in a right angle direction from the axes of rotation of both end portions 8a and 8b, pass through a left side point in the figure on an extension line of a line connecting the axes of rotation of both end portions 8a and 8b to each other in a right angle direction (a lateral direction in FIG. 2), and has an axis of rotation which is arranged in parallel to the axes of rotation of both end portions 8a and 8b, as shown in FIG. 2. The center length portion 8c is integrally formed with both end portions 8a and 8b of the crank-shaped member 8 via both leg portions 8d and 8e having different lengths from each other.

Further, as shown in FIG. 2, between two discs 4 and 6, there is arranged and provided a thick disc-shaped rotating body 20, where a thickness (a height in a longitudinal direction of the sheet of in the figure) is larger than those of the discs 4 and 6, and the thickness is smaller than a diameter.

The rotating body 20 has an axis of rotation which passes through a center of rotation 20C and is arranged in a parallel direction to the axes of rotation of the center length portions 8c of the crank-shaped members 8 (a direction vertical to the sheet surface of the figure), and has shaft support holes 20a to which the center length portions 8c of the crank-shaped members 8 are rotatably fitted while passing through the rotating body 20, as shown in FIG. 4.

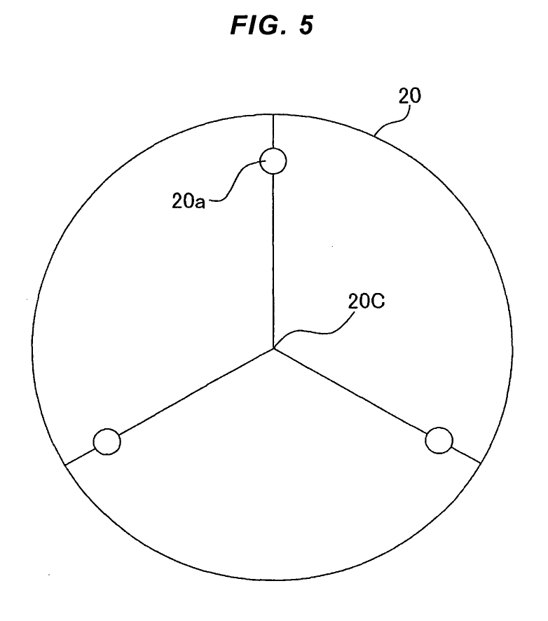

Further, the shaft support holes 20a are formed at three positions in which their centers are arranged at intervals of 120 degrees, in a circumferential direction on the pitch circle of the rotating body 20. As shown in FIG. 5, the rotating body 20 is constructed by three divided members, and the shaft support holes 20a are formed at mating faces thereof, however, three shaft support holes 20a may be formed in a single piece thick disc-shaped member which is not divided into three pieces.

When the one side end portions 8a of the crank-shaped members 8 are rotatably fitted to the shaft support holes 4a of the disc 4, the other side end portions 8b of the crank-shaped members 8 are rotatably fitted to the shaft support holes 6a of the disc 6, and the center length portions 8c of the crank-shaped members 8 is rotatably fitted to the shaft support holes 20a of the rotating body 20 in FIGS. 4 and 5, a line connecting the center of rotation 4C of the disc 4 and the center of rotation 6C of the disc 6 always comes to be in a horizontal direction, as shown in FIG. 4.

The reason why the line connecting the center of rotation 4C of the disc 4 and the center of rotation 6C of the disc 6 comes to be in the horizontal direction as mentioned above is that the centers of rotation of the bearing members 17 and 18 provided at the top end portions of the brackets 14 and 15 are set at the same height.

Accordingly, the line connecting the center of rotation 4C of the disc 4 and the center of rotation 6C of the disc 6 always comes to be in the horizontal direction, and the shaft support holes 4a of the disc 4 and the shaft support holes 6a of the disc 6 are arranged at the same phase on the respective pitch circles in such a manner that they always come to be at the same height, whereby the shaft support holes 4a of the disc 4 and the shaft support holes 6a of the disc 6, to which both end portions 8a and 8b of the crank-shaped members 8 are fitted, always maintain a state of being in a fine in the horizontal direction, as shown in FIG. 4.

Since the shaft support holes 4a of the disc 4 and the shaft support holes 6a of the disc 6 maintain the state of being in a line in the horizontal direction as mentioned above, both leg portions 8d and 8e of the crank-shaped members 8 always maintain the horizontal state via both end portions 8a and 8b of the crank-shaped members 8 which are fitted to the shaft support holes 4a and the shaft support holes 6a.

In FIG. 4, the center of rotation 4C of the disc 4 is a point through which the axis of the rotating shaft 4b in FIG. 2 passes, the center of rotation 6C of the disc 6 is a point through which the axis of the rotating shaft 6b in FIG. 2 passes, and the center of rotation 20C of the rotating body 20 is a point through which the axis passes at a time when the rotating body 20 rotates, as mentioned below.

On the other hand, as shown in FIG. 1, an inner peripheral surface of an inner ring 23a of a bearing member 23 is integrally fitted to an outer peripheral surface of the rotating body 20 so as to be relatively non-rotatable, and a belt 25 is wound around an outer peripheral surface of an outer ring 23b of the bearing member 23.

Since one midway position of an endless length of the belt 25 is locked to an upper end portion of a tensile coil spring 27 provided between the base plate 10 and the belt 25, the rotating body 20 comes to a state of being always pulled toward the base plate 10 via the bearing member 23, the belt 25 and the tensile coil spring 27.

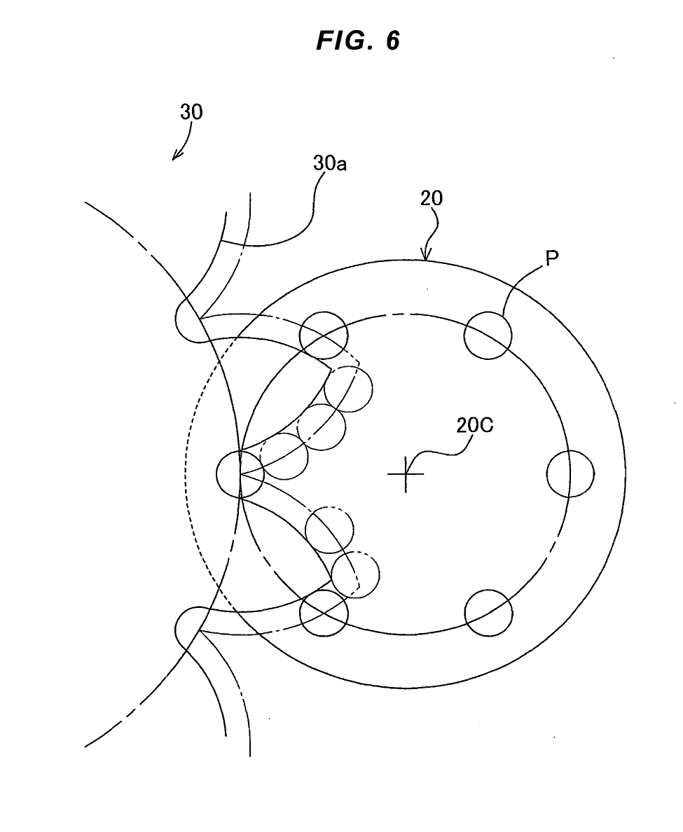

Since six pins P having axes in parallel to the axial direction of the rotating body 20 are provided at an outer peripheral portion (a circumferential portion) side of both front and back faces which are vertical to the axis of the rotating body 20, as shown in FIG. 6, the rotating body 20 has a function serving as a pin gear. As for these six pins P of the rotating body 20, at this time, the center length portions 8c of the crank-shaped members 8 may be used alternately for the pins, or the independent pins P from the center length portion 8c may be used totally without using the center length portion 8c, if there is no interference with the center length portion 8c.

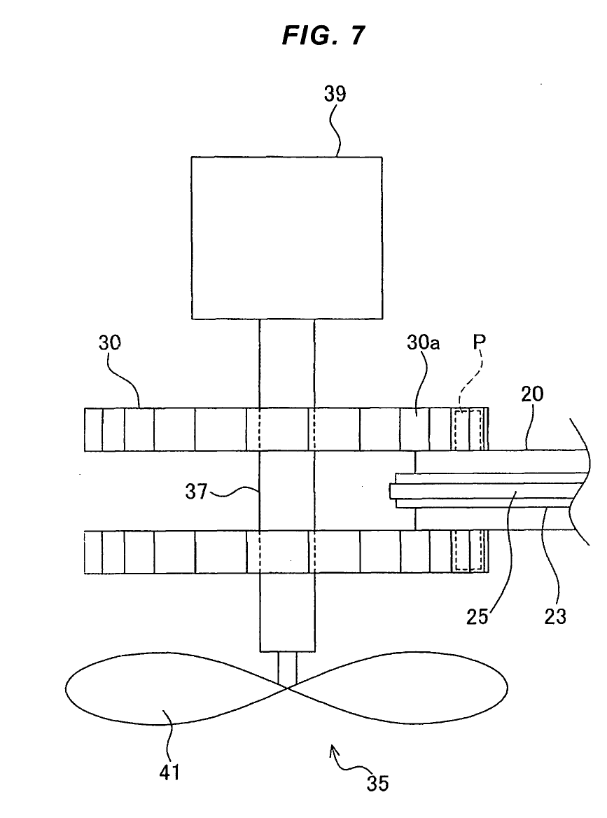

Teeth 30a of a cycloid gear 30 are engaged with the pins P of the rotating body 20 serving as the pin gear as mentioned above, as shown in FIG. 6. Two cycloid gears 30 are arranged at both front and back sides of the rotating body 20, as shown in FIG. 7, and rotation center portions of these two cycloid gears 30 are provided in a rotation transmitting shaft 37 of a ventilating fan apparatus 35 (corresponding to “rotating apparatus” in claim 1) which is in parallel to the axis of the rotating body 20.

A drive motor 39 for driving the rotation of the rotation transmitting shaft 37 is provided at one end portion (an upper end portion in FIG. 7) of the rotation transmitting shaft 37 of the ventilating fan apparatus 35. A fan 41 which is rotationally driven so as to operate as a ventilating fan is provided at the other end portion (a lower end portion in FIG. 7) of the rotation transmitting shaft 37.

Next, a description will be given of a motion of the rotation assisting mechanism 2 as mentioned above.

The rotation assisting mechanism 2 is structured, as shown in FIG. 4 mentioned above, such that both end portions 8a and 8b of three crank-shaped members 8 are rotatably fitted to three pairs of shaft support holes 4a and 6a in such a manner as to keep the positions having the same phase and the same height on the respective pitch circles of two discs 4 and 6, and the line connecting the rotation center 4C of the disc 4 and the rotation center 6C of the disc 6 always comes to be in the horizontal direction. Accordingly, both leg portions 8d and 8e are structured such as to always maintain the horizontal state via both end portions 8a and 8b of the crank-shaped members 8 (refer to FIGS. 2 and 5).

Accordingly, three crank-shaped members 8, in which both leg portions 8d and 8e of the crank-shaped members 8 always maintain the horizontal state as shown in FIG. 4, are arranged at three positions at even intervals in the circumferential direction of the pitch circles on the discs 4 and 6.

When the crank-shaped members 8 are arranged in this state, the center length portions 8c of the crank-shaped members 8 rotate around the center of rotation 20C of the rotating body 20 as mentioned below, whereby one side end portions 8a of the crank-shaped members 8 rotate around the center of rotation 4C of the disc 4, and the other side end portions 8b of the crank-shaped members 8 rotate around the center of rotation 6C of the disc 6.

On the other hand, the center of rotation 20C of the rotating body 20 exists at an outer side (a left side in FIG. 4) of the center of rotation 6C on the extension line of the line connecting the centers of rotation 4C and 6C of two discs 4 and 6, as mentioned above, and the rotating body 20 is always pulled toward the base plate 10 side via the bearing member 23, the belt 25 and the tensile coil spring 27, as shown in FIG. 1.

Further, force applied to the rotating body 20 by the tensile force of the belt 25 is applied to each of the center length portions 8c of three crank-shaped members 8 dispersedly, and it is possible to rotate the rotating body 20 on the basis of a rotational moment generated in each of the center length portions 8c as mentioned below.

In other words, when the rotating body 20 receives the tensile force toward the base plate 10 side (a lower side in FIG. 4) by the tensile coil spring 27, one third of the tensile force is transmitted to each of the center length portions 8c of three crank-shaped members 8. Accordingly, three center length portions 8c generate a rotational moment around the centers of rotation 4C and 6C of the discs 4 and 6 in FIG. 4.

Further, since the center positions of the center length portions 8c of three crank-shaped members 8 are arranged at intervals of 120 degrees on the pitch circle of the rotating body 20, the center length portion 8c of one part among three generates a rotational moment in an opposite direction to the center length portion 8c of an other part. However, since the center positions of the center length portions 8c are arranged so as to be largely shifted in the left direction in FIG. 4 from both the end portions 8a and 8b of the crank-shaped members 8 in the horizontal direction, a total rotational moment calculated by totaling the angular moments applied to three center length portions 8c necessarily generates such a rotational moment that the center length portions 8c rotate in a counterclockwise direction around the centers of rotation 4C and 6C in FIG. 4.

Accordingly, all of the center length portions 8c of three crank-shaped members 8 simultaneously rotate in the counterclockwise direction in FIG. 4, whereby the rotating body 20 rotates in the same direction around the center of rotation 20C. At this time, the centers of rotation 4C, 6C and 20C always maintain a state of being in a line in the horizontal direction.

When the center length portions 8c of the crank-shaped members 8 rotate in the rotating direction of the rotating body 20 as mentioned above, both end portions 8a and 8b of the crank-shaped members 8 maintaining the horizontal state, together with the center length portions 8c, also rotate in the same direction while keeping the same phase as the center length portions 8c. Accordingly, both end portions 8a and 8b of the crank-shaped members 8 fitted to the shaft support holes 4a and 6a are relatively rotate to each other, whereby two discs 4 and 6 also rotate.

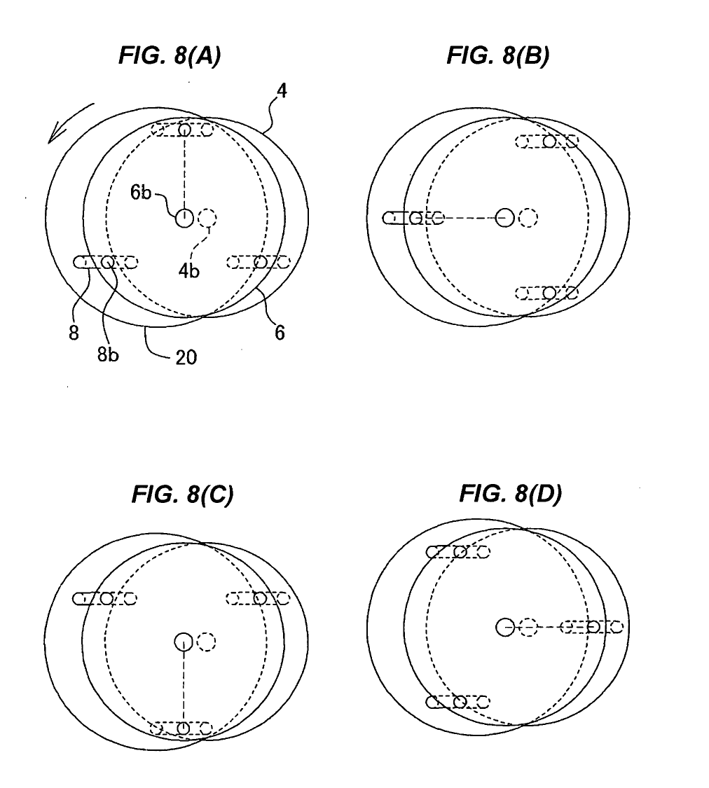

As mentioned above, while the center of rotation 20C does not move, the rotating body 20 can rotate around the center of rotation 20C. For example, FIGS. 8(a) to 8(d) show the state in which the rotating body 20 rotates by 90 degrees each, and are views showing a transition of the position of each of the portions of the crank-shaped members 8.

In other words, in order to explain the rotation of the rotating body 20 in an easy-to-understand way, FIGS. 8(a) to 8(d) show a state in which the end portion 8b (refer to FIG. 4) of the crank-shaped member 8 positioned at the top in the figure apparently rotates around the rotating shaft 6b of the disc 6, where the centers of the rotating shaft 6b and the end portion 8b are connected by a broken line, as shown in FIGS. 8(a) to 8(d), and the rotating body 20 simultaneously rotates around the center of rotation 20C.

When the rotating body 20 rotates, it is possible to rotate the cycloid gear 30 via the teeth 30a engaging with the pins P provided in both the front and back faces of the rotating body 20, as shown in FIG. 6, and it is possible to transmit the rotation to the rotation transmitting shaft 37 driving the fan 41 of the ventilating fan apparatus 35 as shown in FIG. 7, on the basis of the rotation of the cycloid gear 30.

The ventilating fan apparatus 35 is structured, as mentioned above, such that the rotation generated by the rotation assisting mechanism 2 is transmitted to the rotation transmitting shaft 37, whereby the rotating force of the rotation transmitting shaft 37 is assisted, and it is accordingly possible to significantly reduce an output and an electric power consumption of the drive motor 39 driving the rotation of the rotation transmitting shaft 37.

As mentioned above, in accordance with the rotation assisting mechanism 2 on the basis of the present embodiment, it is possible to defend the current civilized living by largely reducing the use amount of the energy for driving the ventilating fan apparatus 35 (the rotating apparatus) in comparison with the conventional one.

In addition, in the rotation assisting mechanism 2 in accordance with the embodiment mentioned above, the structure is made such that the rotation of the rotating body 20 is transmitted to the rotation transmitting shaft 37 of the ventilating fan apparatus 35, by engaging the pins P provided on both the front and back faces of the rotating body 20 with the teeth 30a of the cycloid gear 30, however, the structure is not limited to that mentioned above, but it is possible to employ any other structure, for example, of forming teeth of a spur gear on the outer peripheral portion of the rotating body 20 at both outer sides beyond a width of the bearing member 23, in a width direction of the outer peripheral surface of the rotating body 20, and engaging with teeth of a spur gear provided on the rotation transmitting shaft 37 of the ventilating fan apparatus 35, and the like.

Further, in the rotation assisting mechanism 2 in accordance with the embodiment mentioned above, the description is given of the case that the rotation generated by the rotating body 20 is transmitted to the rotation transmitting shaft 37 of the ventilating fan apparatus 35 so as to assist the rotation thereof, however, the present invention can be applied to a case of assisting rotation of any other rotating apparatus than the ventilating fan apparatus 35.

Further, in the rotation assisting mechanism 2 in accordance with the embodiment mentioned above, the description is given of the case that the flat surfaces of two discs 4 and 6 and the rotating body 20 are in parallel to a vertical surface, however, these flat surfaces may be arranged in such a manner as to be in parallel to a horizontal surface.

Further, in the rotation assisting mechanism 2 in accordance with the embodiment mentioned above, the rotating body 20 is structured such as to be pulled downward in the figure as shown in FIG. 1, however, the rotating body 20 may be structured such as to be inversely pulled upward in the figure. In this case, as is different from the case that the rotating body 20 rotates in the counterclockwise direction in the rotation assisting mechanism 2 in accordance with the embodiment mentioned above, the rotating body 20 rotates in the clockwise direction.

Further, in the rotation assisting mechanism 2 in accordance with the embodiment mentioned above, the description is given of the case that three crank-shaped members 8 are used, however, two crank-shaped members 8 or four or more crank-shaped members 8 may be used.

What is claimed is:

1. A rotation assisting mechanism comprising:
two disc members in which mutual faces are arranged so as to oppose to each other, axes of rotation of the faces are away from each other in a vertical direction with respect to the respective axes, and the axes of rotation are arranged so as to be in parallel to each other;
two or more crank-shaped members formed by both end shaft portions which are rotatably fitted to a plurality of holes formed in such a manner as to have axes in a vertical direction to the respective faces of said two disc members, both leg portions which are arranged so as to be in parallel to each other by bending vertically from end portions at sides close to each other of both the end shaft portions toward the same side and have different lengths from each other, and center shaft portions which couple said both leg portions by bending vertically from the respective end portions at opposite sides to said both end shaft portions of both the leg portions, and have axes of rotation in parallel to the respective axes of rotation of said both end shaft portions; and
a rotating body having a plurality of holes formed in such a manner as to have axes in a parallel direction to its own axis of rotation so that the center shaft portions of said crank-shaped members are rotatably fitted thereto.

2. The rotation assisting mechanism as claimed in claim 1, wherein a plurality of the holes formed in each of said two disc members are constructed by two pairs or more of shaft support holes which are formed so as to mutually make pairs with holes at positions having the same phase on pitch circles of the mutual disc members, at each of positions which are away at even intervals in a circumferential direction, on each of the pitch circles having the same diameter around the axes of rotation in each of these two disc member, and
wherein both the end shaft portions of said crank-shaped members are fitted respectively to the shaft support holes of said two disc members.

3. The rotation assisting mechanism as claimed in claim 1 or 2, wherein the mechanism further comprises an energizing means to energize said rotating body in a vertical direction to the axis of rotation of the rotating body, and in a vertical direction to a straight line connecting the axes of rotation of said two disc members in the vertical direction to the respective axes.

4. The rotation assisting mechanism as claimed in claim 1 or 2, wherein the rotation of said rotating body is made transmittable to an independent rotating apparatus from said rotation assisting mechanism via a gear.
